(19) United States
(12) Patent Application Publication
(10) Pub. No.: US 2025/0051189 A1
(43) Pub. Date: Feb. 13, 2025

(54) REGENERABLE SMART MATERIALS FOR SELECTIVE REMOVAL OF POLLUTANTS FROM WATER AND WASTE WATER

(71) Applicant: EXPOSOME PVT. LTD., Mumbai (IN)

(72) Inventor: Prerna Goradia, Mumbai (IN)

(21) Appl. No.: 18/922,379

(22) Filed: Oct. 21, 2024

Related U.S. Application Data
(63) Continuation of application No. PCT/IN2023/050382, filed on Apr. 20, 2023.

(30) Foreign Application Priority Data
Apr. 20, 2022 (IN) 202221023170

(51) Int. Cl. C02F 1/28; B01D 15/20; B01J 20/30; C02F 101/10; C02F 101/18; C02F 101/20; C02F 101/36; C02F 103/16; C02F 103/18

(52) U.S. Cl. CPC C02F 1/288; B01D 15/203; B01J 20/3071; C02F 1/281; C02F 2101/101; C02F 2101/105; C02F 2101/18; C02F 2101/20; C02F 2101/36; C02F 2103/16; C02F 2103/18; C02F 2201/006; C02F 2303/04; C02F 2303/16; C02F 2303/22

(57) ABSTRACT

The present disclosure relates to a system and regenerable molecular media for wastewater purification treatment and a preparation method thereof. The molecular filter media of the present invention are extremely high surface area filter granules and pellets that are either supplied loose or molded into blocks. The industry uses these for filtration in flow-through filter devices. The disclosed regenerants effectively break bonds and get the molecular filters ready for the next cycle of use.

### RELATED APPLICATIONS

This application claims priority under 35 U.S.C. § 120 to, and is a continuation of, co-pending International Application PCT/IN2023/050382, filed Apr. 20, 2023 and designating the US, which claims priority to IN application 202221023170, filed Apr. 20, 2022, such IN Application also being claimed priority to under 35 U.S.C. § 119. These IN and International applications are incorporated by reference herein in their entireties.

### FIELD

The invention relates to the technical field of wastewater treatment. More particularly, the invention relates to a system and regenerable molecular media for wastewater purification treatment and a preparation method thereof.

### BACKGROUND

For treating water, for the removal of a wide range of pollutants the use of activated carbon is considered to be one of the most economical methods. Activated carbon is used in drinking water treatment for removing organic pollutants. Although it is able to adsorb some inorganic molecules, e.g., phosphates and chromates, adsorption sites available for these components are quite limited.

Recalcitrant compounds or refractory compounds mainly refer to the organic polymeric pollutants from various industries which have predominantly complex aromatic ring structure. Ozonation is widely used to enhance biodegradability and microorganisms, especially fungi are used to degrade such recalcitrant compounds.

The industries which are facing challenges to remove these contaminants are mainly the resin producing industry, pulp and paper industry and bleaching industry. Decolourization of effluents from bleaching and pulp plants is also concerned while dealing with the treatment of recalcitrant organic contaminants. So, an integrated approach comprising all these techniques will give a promising solution to treat the compounds. The most commonly used physico-chemical techniques for treatment of industrial effluents are coagulation-flocculation, chemical precipitation, chemical oxidation, membrane filtration and adsorption. These methods were highly effective in removing BOD and COD but not for recalcitrant compounds. Also, the chemicals used for treatment may cause toxicity and the cost of chemicals is expensive. Therefore, economic and safe treatment is needed for treatment and removal of recalcitrant compounds.

References have been made to the following literature:

CN115057507A relates to a wastewater purification treatment agent and a preparation method thereof, wherein the wastewater purification treatment agent comprises the following raw materials: activated carbon, polymeric ferric sulfate and polymeric aluminum chloride. The powdery wastewater purification treatment agent is obtained by uniformly mixing the activated carbon, the polymeric ferric sulfate and the polymeric aluminum chloride powder in a specific ratio, and particularly, the treatment agent obtained when the mass fraction of total iron in the polymeric ferric sulfate is more than or equal to 21%, the content of aluminum oxide in the polymeric aluminum chloride powder is more than or equal to 29 wt %, and the basicity is 40-55% has excellent adsorption flocculation performance and high reaction speed, can remarkably reduce the COD concentration and turbidity in industrial wastewater, and has an obvious decoloration effect. In addition, the preparation method is simple, convenient to use, safe in components and free of secondary pollution.

Chinese patent CN106517467A discloses a flocculant conforming to polymeric ferric sulfate and containing activated carbon and a preparation method thereof, wherein the flocculant obtained by activated carbon, zeolite, ferric sulfate waste liquid, thiobacillus ferro-oxidans, hydrogen peroxide, agrobacterium tumefaciens, silver nitrate, polyacrylamide, attapulgite, ethylene glycol and water with certain weight has obvious efficiency improvement and stable quality, but the preparation components and the preparation method are more complex, and the cost is increased to a certain extent.

WO-2011016038-A1 relates to the treatment of aqueous fluid polluted with selenium contaminants by mixing with or passing through an adsorbent material selected from: (i) nanoparticles or colloids of oxides or hydroxides of transition metals or of aluminum, or mixtures thereof, or (ii) porous carbon, activated carbon, aluminum oxide or hydroxide, activated alumina, mineral clay, zeolite, or mixtures thereof in granular, particles or powder form, loaded with nanoparticles or colloids of oxides or hydroxides of transition metals or of aluminum, or mixtures thereof, to yield aqueous fluid purified from selenium

JP5244867B2 relates to a filter medium having a microbiological blocking function, a filtration system containing such a filter medium, and a method for producing and using the same.

JP6728133B2 relates to composite particulate filtration media comprising a mixture of particulate filtration media and nanofibers for removing contaminants from water sources such as drinking water for water purification applications.

It is evident that despite the widespread use of activated carbon and zeolites for the treatment of contaminated liquids, industrial waste and sewage water, they have a limited durability. To counteract these claims a reusable and robust platform and materials to reduce the pollutants and lower the COD in waste waters is the need of the hour. The molecular filter media of the present invention are extremely high surface area filter powders and pellets for lowering the COD and removing the pollutants. The technologies are based on basic filtration infrastructure such as sand beds, activated carbons etc. and is a cost-effective technology that performs for difficult to remove pollutants.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The present invention attempts to overcome the problems faced in the prior art, and discloses a system and regenerable molecular media for wastewater purification treatment and a preparation method thereof.

In an embodiment of the present invention, the invention discloses a filter media for removing the pollutants from contaminated liquids comprising about 70-100%, by weight, of microporous activated ceramic powder beads; about 0% to about 20%, by weight, of binders, at least an excipient (Fe, C). The excipient is an active material added to absorb specific contaminants. For preparing the filter media, the activated ceramic beads is mixed with the binder; and the mixture is processed in the extruder to produce high-density extrudates; further, the extrudate is spheronized to convert into green beads by cold process; and finally the green beads sintered to provide stable filter media by removing the binder wholly or partly. The sintering is at least at a temperature of 350° C. or more.

In another embodiment of the present invention, the beads material is at least a porous ceramic powder selected from a group comprising alumina, carbon, silica, zeolite, metal oxide, complex metal oxide such as mica, aluminosilico-oxide and combinations thereof. Further, the ratio of alumina and silica in the beads material is 1:20 to 20:1 and the shape of the beads is at least one selected from spherical, filamentous, star shaped, snow flake like and combinations thereof but not limited to.

In yet another embodiment of the present invention, the bead is activated by active reagent in fusion, extrusion, molding, slip casting, powder coating, wet molding or dry molding of active particles. Further, the binder is at least a liquid and powder converted into liquid format selected from a group comprising PEG, polyvinyl acetate. sucrose, gelatin and starch, cellulose derivatives and polyvinylpyrrolidone, which have improved adhesive properties, cross-linked polyvinylpyrrolidone and microcrystalline cellulose. The excipient comprises materials selected from the group consisting of activated carbon powders, activated carbon granules, activated carbon fibers, zeolites, activated alumina, activated magnesia, diatomaceous earth, sponge iron, activated silica, hydrotalcites, glass, polyethylene fibers, polypropylene fibers, ethylene maleic anhydride copolymer fibers, sand, clay and combinations thereof, but not limited to.

In a preferred embodiment of the present invention, the pore size of the filter media is in a range of 0.02 nm to about 2 nm. In an embodiment, the filter media for removing aluminium contamination from the contaminated liquid contains at least 35% silica beads, alumina and other oxides. In an embodiment, the filter media for removing cyanide contamination from the contaminated liquid contains filament beads with 30% binder, 30% ferrous sulphate and 30% zeolite.

In a preferred embodiment of the present invention, the invention discloses a regenerant for recharging the filter media in the filter, and the regenerant is at least 20% volume of the molecular filter media. In an embodiment, the regenerant is at least one selected from a group comprising acid, alkali, ferrous salts, zinc salts, oxidizer and combinations thereof in at least 90% aqueous composition. Further, the regenerant is selected depending upon the filter media and the pollutants to be filtered from the contaminated liquid. In an embodiment, the regenerant for recharging the alumina filter media after removing heavy metals and silica contamination liquid the regenerant contains 4% acids plus FeCl3, NaOCl and H2O2 or combinations thereof.

In an exemplary embodiment of the present invention, the invention relates to a method for removing trihalomethanes, heavy metals, aluminium, hardness, bacteria, and fungus, comprising providing a filter comprising filter media and pump; followed by providing the contaminated liquid into filter containing the molecular filter media; further, soaking the filter media in the regenerant to effectively regenerate the filter media, once the liquid is purified and the filter media is saturated; and finally reintroducing the effluent for the next filtration cycle.

According to this invention, there is provided a filtration device for purifying contaminated liquid, the filtration device comprising:
at least one frame having an inlet and an outlet;
at least one molecular filter media comprising:
about 70-100%, by weight, of a plurality of filter core components comprising microporous activated granules,
about 0-20% by weight, of a plurality of filter activated components which are extruded and comprise binders,
about 0.5-15%, by weight, of a plurality of filter components comprising active reagents,
a regenerant within the frame, wherein the regenerant is at least an aqueous liquid added, for recharging the filter media; and
a pump configured within the frame for transferring the purified liquid after the filtration therefrom, wherein the pump maintains the pressure in the frame for flow of the liquid in or against gravity.

In at least an embodiment, the molecular filter media is in the form of a cartridge within the frame for filtering the contaminated liquid.

In at least an embodiment, the filter media for removing the pollutants from contaminated liquid comprising:
about 70-100%, by weight, of a plurality of filter particles comprising microporous activated ceramic powder granules;
about 0-20%, by weight, of a plurality of filter particles comprising binders,
at least an active material added to absorb specific contaminants, wherein,
the ceramic beads infused with active reagents being mixed with the binder;
the mixture of beads and binder from step (a) being processed in the extruder to produce high-density extrudates;
spheronizing the extrudates to convert into green beads by a cold process;
sintering the green beads from step (c) to provide stable filter media by removing the binder wholly or partly, wherein the sintering is at least at a temperature of 350°0 C. or more.

In at least an embodiment, the beads material is at least a porous ceramic powder selected from a group comprising alumina, carbon, silica, zeolite, metal oxide, zirconia, complex metal oxide such as mica, alumino silico-oxide and combinations thereof.

In at least an embodiment, the beads material is at least a porous ceramic powder selected from a group comprising alumina, carbon, silica, zeolite, metal oxide, zirconia, complex metal oxide such as mica, alumino silico-oxide and combinations thereof, in that, the ratio of alumina and silica in the beads material is 1:20 to 20:1.

In at least an embodiment, the beads material is at least a porous ceramic powder selected from a group comprising alumina, carbon, silica, zeolite, metal oxide, zirconia, complex metal oxide such as mica, alumino silico-oxide and combinations thereof, in that, the shape of the beads is at least one selected from spherical, filamentous, star shaped, snow flake like and combinations thereof but not limited to.

In at least an embodiment, the beads material is at least a porous ceramic powder selected from a group comprising alumina, carbon, silica, zeolite, metal oxide, zirconia, complex metal oxide such as mica, alumino silico-oxide and combinations thereof, in that, the beads is infused using active reagents comprising metal salts (to impart selective absorption properties to the beads) using the process selected from extrusion, molding, slip casting, powder coating, wet molding or dry molding of active particles.

In at least an embodiment, the binder is at least a liquid and powder converted into liquid format selected from a group comprising PEG, polyvinyl acetate. sucrose, gelatin and starch, cellulose derivatives and polyvinylpyrrolidone, which have improved adhesive properties, cross-linked polyvinylpyrrolidone and microcrystalline cellulose.

In at least an embodiment, the excipient comprises materials selected from the group consisting of activated carbon powders, activated carbon granules, activated carbon fibers, graphene, zeolites, activated alumina, activated magnesia, diatomaceous earth, sponge iron, activated silica, hydrotalcites, glass, polyethylene fibers, polypropylene fibers, ethylene maleic anhydride copolymer fibers, sand, clay and combinations thereof, but not limited to.

In at least an embodiment, the pore size of the filter media is defined by the particular ion used in the preparation of the material within a range of 0.02 nm to about 2 nm.

In at least an embodiment, the filter media comprises,
70% alumina and 30% binder, which after spheronization and drying is treated with 6% KMnO4 mixed in power and for sintering heated to 350 to provide ceramic beads; and
at least 20% ceramic beads from step a) treated with at least 80% core component, wherein the core component is high quality carbon for effectively adsorbing recalcitrant organics and inorganics; for lowering chemical oxygen demand of the contaminated liquid.

In at least an embodiment, the filter media comprises at least 94% alumina and other oxides for removing silica contamination of the contaminated liquid.

In at least an embodiment, the filter media comprises filament beads with 30% binder, 30% ferrous sulphate, and 40% zeolite for removing cyanide contamination of the contaminated liquid.

In at least an embodiment, the regenerant for recharging the filter media in the filter comprising at least one of a group comprising acid, alkali, ferrous salts, zinc salts, oxidizer and combinations thereof in at least 90% aqueous composition.

In at least an embodiment, the regenerant for recharging the filter media in the filter comprising at least one of a group comprising acid, alkali, ferrous salts, zinc salts, oxidizer and combinations thereof in at least 90% aqueous composition, in that, the regenerant is at least 20% volume of the molecular filter media.

In at least an embodiment, the regenerant for recharging the filter media in the filter comprising at least one of a group comprising acid, alkali, ferrous salts, zinc salts, oxidizer and combinations thereof in at least 90% aqueous composition, in that, the regenerant is selected for depending upon the filter media and the pollutants to be filtered from the contaminated liquid.

In at least an embodiment, the regenerant for recharging the filter media in the filter comprising at least one of a group comprising acid, alkali, ferrous salts, zinc salts, oxidizer and combinations thereof in at least 90% aqueous composition, in that, the regenerant contains 4% acids plus FeCl3, NaOCl and H2O2 or combinations thereof for recharging the alumina filter media after removing heavy metals and silica contamination liquid.

According to this invention, there is provided a method for removing trihalomethanes, heavy metals, aluminium, hardness, bacteria, and fungus, comprising:
providing a filter comprising filter media and pump;
providing the contaminated liquid into filter containing the molecular filter media;
soaking the filter media in the regenerant to effectively regenerate the filter media, once the liquid is purified and the filter media is saturated; and
reintroducing the effluent for the next filtration cycle.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

The terms “comprises”, “comprising”, or any other variations thereof used in the disclosure, are intended to cover a non-exclusive inclusion, such that a device, apparatus, system, assembly, method that comprises a list of components or a series of steps that does not include only those components or steps but may include other components or steps not expressly listed or inherent to such apparatus, or assembly, or device. In other words, one or more elements or steps in a system or device or process proceeded by “comprises . . . a” or “comprising . . . of” does not, without more constraints, preclude the existence of other elements or additional elements or additional steps in the system or device or process as the case may be.

Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion. The use of “etc.” is defined as “et cetera” and indicates the inclusion of all other elements belonging to the same group of the preceding items, in any “and/or” combination(s). Modifiers “first,” “second,” “another,” etc. may be used herein to describe various items, but they do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise.

Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

The inventor has recognized that despite the widespread use of the available treatments for lowering the pollutants the recalcitrant COD is not adequately lowered and the operational expenditures are also very high. Further, due to the filtering media being used up during the process, the operational costs are high. Thus, a need remains for a novel regenerant filter media methodology in such applications which besides environmentally friendly is both economical as well as provide excellent results for removing the pollutants and lowering the recalcitrant COD. To overcome these issues, the inventor has developed example embodiments and methods described below to address these and other problems recognized by the Inventors with unique solutions enabled by example embodiments.

In an embodiment, the present invention relates to a system and method for reducing the recalcitrant chemical oxygen demand, herein referred to as COD, the inorganic and organic pollutants in the wastewater, sewage, medical waste water and industrial waste water. The molecular filter media of the present invention are extremely high surface area filter powders and pellets that are either supplied loose where the industry uses it into their stacks and pre-existing filter devices. The technologies are based on basic filtration infrastructure such as sand beds, activated carbons etc. and is a cost-effective technology that performs for difficult to remove pollutants.

In a preferred embodiment of the present invention, the invention relates to a filtration device for purifying contaminated liquids. The filtration device comprises of (a) at least one frame having an inlet and an outlet; and (b) at least one molecular filter media comprising (i) from about 70-80%, by weight, of a plurality of filter core components comprising microporous activated beads, (ii) from about 0-20% by weight, of a plurality of filter activated components which are extruded and may contain binders, and (iii) from about 0.5% to about 5%, by weight, of a plurality of filter particles components comprising excipients; (c) a regenerant within the frame, wherein the regenerant is at least an aqueous liquid added, for recharging the filter media; (d) a pump within the frame for transferring the liquid after the filtration from, wherein the pump is for maintaining the pressure in the frame for flow of the liquid in or against gravity.

In another embodiment of the present invention, the molecular filter media of the present invention is in the form of a cartridge within the frame for filtering the contaminated liquid.

In an exemplary embodiment of the present invention, the invention discloses a filter media for removing the pollutants from contaminated liquids comprising about 70-100%, by weight, of a plurality of filter particles comprising microporous activated ceramic powder beads; from about 0% to about 20%, by weight, of a plurality of filter particles comprising binders, at least an excipient (Fe, C) wherein the excipient is an active material added to absorb specific contaminants. For preparing the filter media, a) the activated ceramic beads is mixed with the binder; (b) followed by processing the mixture of beads and binder from step a) in the extruder to produce high-density extrudates; (c) spheronizing the extrudates to convert into green beads by cold process; and finally (d) sintering the green beads from step (c) to provide stable filter media by removing the binder wholly or partly, wherein the sintering is at least at a temperature of 350° C. or more.

In another embodiment of the present invention, the beads material is at least a porous ceramic powder selected from a group comprising alumina, carbon, silica, zeolite, metal oxide, complex metal oxide such as mica, aluminosilico-oxide and combinations thereof. Further, the ratio of alumina and silica in the beads material is 1:20 to 20:1 and the shape of the beads is at least one selected from spherical, filamentous, star shaped, snow flake like and combinations thereof but not limited to.

In yet another embodiment of the present invention, the beads is activated by KMNO4 infusion, extrusion, molding, slip casting, powder coating, wet molding or dry molding of active particles.

In still another embodiment of the present invention, the binder is at least a liquid and powder converted into liquid format selected from a group comprising PEG, polyvinyl acetate. sucrose, gelatin and starch, cellulose derivatives and polyvinylpyrrolidone, which have improved adhesive properties, cross-linked polyvinylpyrrolidone and microcrystalline cellulose.

In another embodiment of the present invention, the excipient comprises materials selected from the group consisting of activated carbon powders, activated carbon granules, activated carbon fibers, zeolites, activated alumina, activated magnesia, diatomaceous earth, sponge iron, activated silica, hydrotalcites, glass, porcelain, polyethylene fibers, polypropylene fibers, ethylene maleic anhydride copolymer fibers, sand, clay and combinations thereof, but not limited to. In an embodiment, the excipients are high quality carbon, with activated carbon approx. 79% of various mesh sizes. 75% of excipient is of 30/60 mesh size which is in range of 400-500 microns and mixing with 4/8 mesh size gives it the requisite structure.

In a preferred embodiment of the present invention, the pore size of the filter media is defined by the particular ion used in the preparation of the material with a range of 0.02 nm to about 2 nm.

In an embodiment of the present invention, the filter media for lowering the chemical oxygen demand of the contaminated liquid contains: 70% alumina and 30% binder, which after spheronization and drying is treated with 6% KMnO4 mixed in power and for sintering heated to 350 to provide ceramic beads; and at least 20% ceramic beads from step a) is treated with at least 80% excipient, where the excipient is high quality carbon for effectively adsorbing recalcitrant organics and in-organics.

In yet another embodiment of the present invention, the filter media for removing aluminium contamination from the contaminated liquid contains at least 35% silica bead, alumina and other oxides. In an embodiment, the filter media for removing cyanide contamination from the contaminated liquid contains filament beads with 30% binder, 30% ferrous sulphate, and 30% zeolite.

In a preferred embodiment of the present invention, the invention discloses a regenerant for recharging the filter media in the filter, and the regenerant is at least 20% volume of the molecular filter media. In an embodiment, the regenerant is at least one selected from a group comprising acid, alkali, ferrous salts, zinc salts, oxidizer and combinations thereof in at least 90% aqueous composition. Further, the regenerant is selected for depending upon the filter media and the pollutants to be filtered from the contaminated liquid.

In another embodiment of the present invention, the regenerant for recharging the alumina filter media after removing heavy metals and silica contamination liquid the regenerant contains 4% acids plus FeCl3, NaOCl and H2O2 or combinations thereof.

In an exemplary embodiment of the present invention, the invention relates to a method for removing trihalomethanes, heavy metals, aluminium, hardness, bacteria, and fungus, comprising providing a filter comprising filter media and pump; followed by providing the contaminated liquid into filter containing the molecular filter media; further, soaking the filter media in the regenerant to effectively regenerate the filter media, once the liquid is purified and the filter media is saturated; and finally reintroducing the effluent for the next filtration cycle.

In an embodiment, the material has excellent absorbing and redox ability to break down organics into simpler molecules. It also has excellent antimicrobial properties to resist biofouling.

TABLE 1(a)

| PHYSICAL | |
|---|---|
| PARAMETER | RESULTS |
| Moisture % | 2 |
| Bulk density | 750 |
| kg/m³ | |
| Appearance | Mixed media |

TABLE 1(b)

| CHEMICAL PARAMETER | RESULTS |
|---|---|
| pH range | 2-12 |
| Max operating temperature | <200° C. |
| Differential pressure | 0.85 kg/cm² |
| Backwash | 30 m³/hr/m² minimum |
| Flow-rate | 5-30 m³/hr/m² |

In an embodiment, the oxidants and the media work together to oxidize a dissolved solid into a suspended solid that is then filtered out. The media facilitates chemical reactions and removes the solids created by the oxidation that are then periodically backwashed out of the filter vessels. Chlorine, fed as sodium hypochlorite or bleach (>12.5% NaOCl), is the preferred oxidant since it is relatively inexpensive, readily available around the world and is effective. Other oxidants such as hydrogen peroxide (H2O2), chlorine dioxide (ClO2) or ozone can also be used so long as a residual can be measured and maintained.

In an embodiment, the regenerant is introduced into the media (about 10-20% volume to weight) and allowed to stagnate for at least one hour and preferably overnight. The media is then flushed out with water and the leachate is reused and or neutralized for proper disposal.

In an embodiment, the concept of oxidizing and reducing beads is introduced where the special resistant zirconia beads are impregnated with oxidizing and or reducing agents. For example, peroxide/oxidizing agents are impregnated to cure scrubber water having sulphite/bisulphite which is then oxidized to sodium sulphate and water. Sodium sulphate can then be used for industrial purposes such as the manufacture of cement. The treated water can be reused for the application. Eventually approaches such as this would be used to oxidize and reduce species in water scrubbers to industrially relevant ones where the molecules can be repurposed. For the reduction process sodium metabisulphites, organic acids such as ascorbic, oxalic acids, phosphites, phosphorous acid, hypophosphites can be used.

### EXAMPLES

### Example 1: For Lowering the COD

The filter media was produced as per the scheme containing 70% alumina powder and 30% binder, which after spheronization and drying was treated with 4-10% KMnO4 mixed in power, followed by sintering by heating to 350-750° C. to provide ceramic beads. Of these beads produced, at least 20% ceramic beads from this previous step were treated with at least 80% excipient, with the excipient being a high-quality carbon for effectively adsorbing the pollutant molecules. Further the regenerant for this COD lowering filter media was 4% HCl+4% H2SO4 with 0.1% by weight FeCl3 in water.

### Example 2: For Removing Silica and Heavy Metals such as Mn, Fe, As, Pb, H2S

The filter media was produced as per the scheme containing more than 94% alumina and the rest binder, which after spheronization and drying was treated with <1% KMnO4, followed by sintering by heating to 750° C. to provide ceramic beads. These beads were directly used as the silica concentration lowering molecular filter. Further, for recharging the alumina filter media after removing the heavy metals and silica from the effluent, the regenerant was added containing 4% acids plus FeCl3, NaOCl and H2O2, NaOH or combinations thereof.

For silica removal:

The molecular filter with superior adsorption potency was used for the removal of silica. The regenerant used was a base such as sodium hydroxide or dilute solution of amine where the silica underwent an ion exchange reaction with the surface hydroxide.

TABLE 2
Lowering of silica contamination from the effluent

| | Silica | | | % Reduction |
|---|---|---|---|---|
| | (ppm) | | pH | in silica |
| Control Sample | ~73 | ppm | 8-9 | |
| After treatment | 16 | ppm | 8 | 78% |
| After treatment | 30 | ppm | 8 | 59% |
| and flow 25 liters | | | | |
| at 10 l/hr through | | | | |
| 200 g column | | | | |

For lowering the amount of lead contamination in the sample: The molecular filter media with superior adsorption potency as per scheme in example 2, was used for the removal of lead. The regenerant used was an acid where the lead underwent a ceramic ion exchange reaction with Hydrogen ions from acid regenerant replaced by metal ions.

TABLE 3
Data for lowering the amount of lead contamination in the sample

| | | After soaking in | % decrease |
|---|---|---|---|
| | Before | metal removing | in lead |
| Sample | treatment | molecular filter | content |
| agrochemicals | 13 | 5 | 61.5 |
| mining industry | 1.7 | 0.2 | 88.2 |

### Example 3: For Removing Hardness

The filter media was produced as per the scheme containing more than 94% alumina, 3-4% silica and the rest 2-3% binder with traces of exchangeable ions such as sodium and potassium, which after spheronization and drying followed by sintering by heating to 250° C. to provide ceramic beads. These beads were directly used as the hardness lowering molecular filter. Further, for recharging the filter media after filtering the effluent, the regenerant was added containing 0-50% NaOH, amines or combinations thereof. The ratio of sodium:silica:alumina in the ion exchange process was in the range of 1:1:2.

### For the Removal of Hardness of Water:

Firstly, the amount of hardness present in given water samples was identified using different media and molecular filter were used as per example (3) given above. As per observation the total hardness of sample solution which was blank and after overnight keeping in our media showed a good lowering of the hardness of the water.

TABLE 4
Results for lowering of hardness of water
with the molecular filter media (in ppm)

| Sample/Type of media | 1 | 2 | 3 | 4 |
|---|---|---|---|---|
| Effluent (Blank) | 12400 | 6080 | 9360 | 5280 |
| Sample after treatment | 5440 | 4080 | 6520 | 2760 |
| with Molecular filter | | | | |

Once the filter media was saturated, the regenerant was added and filter media was regenerated and used again. During the treatment process, the Na ion in the molecular filter media was replaced with Ca/Mg and after regenerant treatment now Ca/Mg removed and the sites were vacant for more filtration process.

TABLE 5
Results for lowering of Ca/Mg of water
with the molecular filter media

| Sample/type of media | 1 | 2 | 3 | 4 |
|---|---|---|---|---|
| Blank | 11720 | 5120 | 8640 | 3600 |
| Sample after treatment | 2400 | 880 | 7520 | 880 |
| with regenerant | | | | |

### For Removal of the Calcium Ions

Firstly, the amount of hardness present in water samples from four different sources was identified using different media and Molecular filter were used as per example (3) given above. As per observation the total hardness of sample solution which was blank and after overnight keeping in our media showed a good lowering of the hardness of the water.

TABLE 6
Results for lowering of calcium ions from
water with the molecular filter media

| Sample/Type of media | 1 | 2 | 3 | 4 |
|---|---|---|---|---|
| Blank (ppm) | 2280 | 1520 | 2080 | 1400 |
| Sample after treatment | 600 | 840 | 600 | 400 |
| Molecular filters (ppm) | | | | |

### Example 4: For Removing Orthophosphites

The filter media was produced as per the scheme containing more than 94% alumina and rest binder, which after spheronization and drying was treated with 15% KMnO4, followed by sintering by heating to350 C. degrees to provide ceramic beads. These beads were directly used for orthophosphate removal. Further, for recharging the filter media after treating the effluent, the regenerant was added containing NaOCl and H2O2 or combinations thereof with other oxidants. Instead of KMnO4 other oxidizing agents such as salts of chromate and or ceria could be used.

### For the Lowering of Sodium Orthophosphites in Electroless Nickel Used Plating Bath Solution:

The orthophosphite levels in the bath have to be kept below 100 g/l for it to function well. The effluent was treated with the specific filter media and it was observed that it resulted in the breakdown of orthophosphite so that the bath can be used for longer and greater number of metal turnovers. It was concluded that in aged bath the amount of sodium orthophoshite lowered from 153.92 gm/L to about 44.4 g/L after passing through filter media.

TABLE 7
Results showing the lowering of Sodium Orthophosphites

| Sample/Type of media | 1 | 2 | 3 | 4 |
|---|---|---|---|---|
| Blank (ppm) | 2280 | 1520 | 2080 | 1400 |
| Sample after treatment | 600 | 840 | 600 | 400 |
| Molecular filters (ppm) | | | | |

### Example 5: For Removing Bisulphites

The filter media was produced as per the scheme containing about 60% alumina, 2-10% zirconia, 35% silica and rest binder, which after spheronization and drying was sintered by heating to 350-750 C. degrees to provide toughened ceramic beads. These beads were hardy substrates for absorbing and then imparting oxidizing and reducing agents effectively to transform waste water. For example for recharging the filter media for treating the bisulphate effluent, the regenerant containing NaOCl and H2O2 or combinations thereof were used with other oxidants such as aeration with air.

### Example 6: For Removing Cyanides

The filter media was produced as per the scheme containing and drawn into filaments with 10-30% binder, 10-30% ferrous sulphate and 30-50% zeolite, which after drying was undertaken followed by sintering by heating to 350 C. degrees to seal the actives in the matrix. Further, for recharging the filter media after treating the effluent, the regenerant was added containing ferrous sulphates and reducing agents or combinations thereof.

### Example 7: For Removing Aluminium Contamination

The filter media was produced as per the scheme with 30% binder, 20-30% silica and rest some other metal oxides and exchangeable ions such as sodium, lithium and zirconium, which was subjected to spheronization and drying followed by sintering by heating to750° C. s to provide glassy ceramic beads. Further, for recharging the filter media after treating the effluent, the regenerant was added containing >10% NaOH, amines, HCl and combinations thereof.

To control the amount of aluminium in anodizing bath, the bath was treated with the molecular filter media as stated in the above scheme (example 7) and the amount of aluminium was calculated before and after treatment. From the results it was observed that the molecular filter media was effectively able to decreases the total Al-content from 12.42 g/L to 5.94 g/L.

TABLE 8
Data for lowering the aluminium contamination
with the molecular filter media

| Sample | Al content in g/L |
|---|---|
| Sample as it | 12.42 |
| After treatment with | 5.94 |
| the filter media | |

### Example 8: For Converting Scrubber Water Containing Mixture of Sulphites and Bisulphites into Sulphates

The filter media was produced as per the scheme containing about 60% alumina, 2-10% zirconia, 35% silica and rest binder, which after spheronization and drying was sintering by heating to 350-750° C. degrees to provide toughened ceramic beads. These beads were hardy substrates for absorbing and then imparting oxidizing and reducing agents effectively to transform waste water. For example, for recharging the filter media for treating the bisulphite effluent, the regenerant containing NaOCl and H2O2 or combinations thereof were used with other oxidants such as aeration with air.

To study the conversion of sulphates from bisulphite and sulphite, the concept of oxidizing and reducing beads was introduced where the special resistant zirconia beads was impregnated with oxidizing and or reducing agents. For example, peroxide/oxidizing agents were impregnated to cure scrubber water having sulphite/bisulphite which was then oxidized to sodium sulphate and water. Sodium sulphate could be further used for industrial purposes such as the manufacture of cement and the treated water be reused for the application. The value of Blank was 68.0 cm3.

TABLE 9
Results showing the lowering of sulphites and bisulphites

| | Titrant | Na₂SO₃ | |
|---|---|---|---|
| Experiment | in cm3 | test | NaHSO₃ |
| 500 ml sample + 5 ml of | 49.0 | Positive | Negative |
| 35% H2O2 impregnated | | | |
| beads, aerated for 1 hr | | | |

Since in the above experiment some amount of the sulphite was still left, the further experimentation was done as below.

TABLE 10
Results showing removal of sulphites and bisulphites

| | Titrant | | |
|---|---|---|---|
| Experiment | in cm3 | Na2SO3 | NaHSO3 |
| 400 ml of as it is water heated | 56.5 | Negative | Negative |
| at 45 C. for 1 hr, 4 ml of 35% | | | |
| H₂O₂impregnated beads | | | |
| added and aerated for 1 hr | | | |
| Again aerated for 1 hr | 56.5 | | |
| Further 4 ml of 35% | 68.3 | Negative | Negative |
| H₂O₂regenerant in beads | | | |
| added, aerated for 1 hr | | | |

### Example 9: Flow-Mode Experiments for treatment of Industrial Effluents

The industrial effluent was flown through a cartridge in the flow mode and the flow-rate was maintained at 10 liters per hour. The amount of COD lowering media in the column was ˜180 g. It was observed that after repeated filtration the filter media was saturated and to regenerate the filter media, the regenerant was introduced into the media for overnight interaction with the filter media. The filtering capacity of this treated filter media was restored after the regenerant treatment

TABLE 11
Data for the flow-mode experiments for
treatment of industrial effluents

| Titrant reading, | | |
|---|---|---|
| mL/COD Before | COD after passage | Volume of the |
| passage through | through molecular | industrial |
| molecular filter | filter (ppm) | effluent treated |
| 9664 ppm | 3200 | Upto 5 liter |
| | 3200 | Upto 7 liter |
| | 4672 | Upto 8 liter |
| | 5312 | Upto 14 liter |

100 mL regenerant was stagnated in the saturated filter media for
overnight treatment.

| | |
|---|---|
| 2752 ppm | Restored to as |
| | before COD |

In accordance with advantages of the present invention as compared with the existing formulations, the present invention is to provide a big change in the field of waste water treatment, with a cost efficient and reusable energy efficient process of reducing the pollutants and lowering the COD for waste water treatment. Challenging industrial wastewater treatment applications often do not have functional COD lowering mechanisms, such as with metal finishing, food and beverage oil and gas produced water, fractional flow-back, and production and industrial waste water from metal finishing and textile dyeing industries. Also, there is a need for finding cost-effective ways to recycling the filter media to lower the cost of operation. The initial treatment step may comprise of oxidants and the media working together to oxidize a dissolved solid into a suspended solid that is then filtered out. The second step of the integrated process is where the saturated filter media is treated with the regenerant to recharge the filter media to further remove dissolved organic and inorganic compounds and finally, the purified effluent is suitable for discharge or reuse.

Eventually approaches such as conversion of sulphates from bisulphite and sulphite would be used to oxidize and reduce species in water scrubbers to industrially relevant ones where the molecules can be repurposed. For the reduction process sodium metabisulphites, organic acids such as ascorbic, oxalic acids, phosphites, phosphorous acid, hypophosphites can be used for example.

TECHNICAL ADVANTAGES: Advanced Effluent Treatment molecular filters (media) to remove/reduce recalcitrant COD/turbidity and color and improve efficiency of the effluent treatment plants (ETP's); Customizable filter media which can be designed to remove selective molecules from effluent streams-such as persistent organics, silica, recalcitrant COD, cyanides, heavy metals and sulphides as per the effluent and the respective contaminants; Regenerable Media which can be used for multiple cycles, with on-site regeneration process.

The molecular filters are extremely high surface area filter powders and pellets that are either supplied loose where the industry uses it into their stacks and pre-existing filter devices or can be molded into blocks for the same purpose.

The technologies are based on plug and play flow mode filtration set-ups and basic filtration infrastructure such as sand beds, activated carbons etc.

A cost-effective technology that performs for difficult to remove pollutants.

The molecular filters are designed to remove selective molecules from effluent streams—such as persistent Organics, Silica, COD, Cyanides, Heavy Metals, Sulphides etc. eliminating the cumbersome processes and chemicals used at the Effluent treatment plants (ETPs) to treat them.

The filter media can be introduced in the FRP (fiber reinforced plastic which is a plastic type material in which we fill the molecular filter) cased system at the outlet of problem effluent. The media arrests the problem in the wastewater and provides colorless odorless and clean water (in most of the cases—case depended) for either recycling or for some further treatment at the plant ETP.

Generally, the filter media are used in tertiary treatments but can be used as primary treatment before the RO water treatment, so if ions are removed initially only then increases the life of membrane filters. This pretreatment helps to reduce a lot of expensive chemical usage in ETP's.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

Although embodiments for the present invention have been described in language specific to structural features, it is to be understood that the present invention is not necessarily limited to the specific features described. Rather, the specific features and methods are disclosed as embodiments for the present invention. Numerous modifications and adaptations of the system/component of the present invention will be apparent to those skilled in the art, and thus it is intended by the appended claims to cover all such modifications and adaptations which fall within the scope of the present invention.

1. A filtration device for purifying contaminated liquid, the filtration device comprising:
a frame having an inlet and an outlet;
a molecular filter media including,
about 70-100%, by weight, of a plurality of filter core components having microporous activated granules,
about 0-20%, by weight, of a plurality of filter activated components that are extruded and include binders, and
about 0.5-15%, by weight, of a plurality of filter components having active reagents;
a regenerant within the frame, wherein the regenerant is an aqueous liquid configured to recharge the filter media; and
a pump within the frame, wherein the pump is configured to transfer the purified liquid after filtration and maintain a pressure in the frame for flow of the liquid.

2. The filtration device of claim 1, wherein the molecular filter media is in the form of a cartridge within the frame for filtering the contaminated liquid.

3. The filtration device of claim 1, wherein the filter media for removing the pollutants from contaminated liquid includes,
about 70-100%, by weight, of a plurality of filter particles having microporous activated ceramic powder granules,
about 0-20%, by weight, of a plurality of filter particles having binders, and
an active material configured to absorb specific contaminants, wherein, the ceramic beads infused with active reagents are mixed with the binder, wherein the mixture of beads and binder are processed in the extruder to produce high-density extrudates, wherein the extrudates are spheronized so as to convert the extrudates into green beads by a cold process, wherein the filter media is provided by sintering the green beads by removing the binder wholly or partly, and wherein the sintering is at least at a temperature of 350° C. or more.

4. The filter device of claim 3, wherein the beads material is a porous ceramic powder including at least one of, alumina, carbon, silica, zeolite, metal oxide, zirconia, a complex metal oxide, and alumino silico-oxide.

5. The filter device of claim 3, wherein the beads material is a porous ceramic powder including at least one of, alumina, carbon, silica, zeolite, metal oxide, zirconia, complex metal oxides, and alumino silico-oxide, and wherein a ratio of alumina and silica in the beads material is 1:20 to 20:1.

6. The filter device of claim 3, wherein the beads material a porous ceramic powder including at least one of, alumina, carbon, silica, zeolite, metal oxide, zirconia, a complex metal oxide, and alumino silico-oxide, shaped into spherical, filamentous, star shapes, and/or snow flakes.

7. The filter device of claim 3, wherein the beads material is a porous ceramic powder including at least one of alumina, carbon, silica, zeolite, metal oxide, zirconia, a complex metal oxide, and alumino silico-oxide, and wherein the beads are infused using active reagents including metal salts to impart absorption properties to the beads using at least one of extrusion, molding, slip casting, powder coating, wet molding, and dry molding of active particles.

8. The filter device of claim 3, wherein the binder a liquid or a powder converted into liquid, and wherein the binder includes at least one of PEG, polyvinyl acetate, sucrose, gelatin, starch, cellulose derivatives, polyvinylpyrrolidone, cross-linked polyvinylpyrrolidone, and microcrystalline cellulose.

9. The filter device of claim 3, wherein the excipient includes at least one of, activated carbon powders, activated carbon granules, activated carbon fibers, graphene, zeolites, activated alumina, activated magnesia, diatomaceous earth, sponge iron, activated silica, hydrotalcites, glass, polyethylene fibers, polypropylene fibers, ethylene maleic anhydride copolymer fibers, sand, and clay.

10. The filter device of claim 3, wherein the pore size of the filter media is defined by the particular ion used in the preparation of the material within a range of 0.02 nm to about 2 nm.

11. The filter device of claim 3, wherein the filter media further includes,
70% alumina and 30% binder, which after spheronization and drying is treated with 6% KMnO4 mixed in power and sintered at 350° C. to provide ceramic beads, and
at least 20% ceramic beads with at least 80% core component, wherein the core component is high quality carbon for effectively adsorbing recalcitrant organics and inorganics and lowering chemical oxygen demand of the contaminated liquid.

12. The filter device of claim 3, wherein the filter media includes at least 94% alumina and other oxides for removing silica contamination of the contaminated liquid.

13. The filter device of claim 3, wherein the filter media includes filament beads with 30% binder, 30% ferrous sulphate, and 40% zeolite for removing cyanide from the contaminated liquid.

14. The filtration device of claim 1, wherein the regenerant for recharging the filter media in the filter comprising at least one of a group comprising acid, alkali, ferrous salts, zinc salts, oxidizer and combinations thereof in at least 90% aqueous composition.

15. The filtration device of claim 1, wherein the regenerant for recharging the filter media in the filter includes at least one of, acid, alkali, ferrous salts, zinc salts, and oxidizer, in at least 90% aqueous composition, and wherein the regenerant is at least 20% volume of the molecular filter media.

16. The filtration device of claim 1, wherein the regenerant for recharging the filter media in the filter includes at least one of, acid, alkali, ferrous salts, zinc salts, and oxidizer, in at least 90% aqueous composition, and wherein the regenerant is selected based on the filter media and the pollutants to be filtered from the contaminated liquid.

17. The filtration device of claim 1, wherein the regenerant for recharging the filter media in the filter includes at least one of, acid, alkali, ferrous salts, zinc salts, and oxidizer, in at least 90% aqueous composition, wherein the regenerant contains 4% acids ad at least one of FeCl3, NaOCl and H2O2 configured to recharge the alumina filter media after removing heavy metals and silica contamination liquid.

18. A method for removing trihalomethanes, heavy metals, aluminium, hardness, bacteria, and fungus, comprising:
providing a filter comprising filter media and pump;
providing a contaminated liquid into the filter containing a molecular filter media;
soaking the filter media in the regenerant to effectively regenerate the filter media, once the liquid is purified and the filter media is saturated; and
reintroducing the effluent for the next filtration cycle.
